(19) United States
(12) Patent Application Publication
(10) Pub. No.: US 2005/0235005 A1
(43) Pub. Date: Oct. 20, 2005

(54) Computer system configuring file system on virtual storage device, virtual storage management apparatus, method and signal-bearing medium thereof

(75) Inventor: Hiroshi Aono, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 11/108,852

(22) Filed: Apr. 19, 2005

(30) Foreign Application Priority Data
Apr. 20, 2004 (JP) 123787/2004

(51) Int. Cl. G06F 17/30

(52) U.S. Cl. 707/201

(57) ABSTRACT

A computer system includes a plurality of storage devices, a plurality of client terminals, a file server, and a storage area network. The file server, as a virtual storage management apparatus, allocates virtual storage spaces to the plurality of storage devices for configuring a virtual storage device. The file server includes an information table which defines correspondences between the virtual storage spaces and the client terminals. In the information table, each client terminal is preferably allocated to different virtual storage spaces. When the file server receives a request from the client terminal for accessing the virtual storage device, the file server processes a request based on the information table.

### BACKGROUND OF THE INVENTION

1. Field of the Invention

The present invention relates to a computer system configuring a file system on a virtual storage device, and more particularly to a computer system configuring a file system on a virtual storage device with a plurality of storage devices, a virtual storage management apparatus, a storage management method, and a signal-bearing medium thereof.

2. Description of the Related Art

Several technologies for configuring a file system constituted by a virtual storage device have been known. In one case, a file server, a plurality of client terminals and a plurality of physical disc devices (hereinafter referred to as “storage devices”) are connected to a storage area network (SAN). The file sever couples the plurality of storage devices on a storage area network to form a single virtual storage device, thus configuring the file system.

However, when the plurality of client terminals makes a request for accessing the virtual storage device, e.g. a request for generating a file and an IO request (write/read), there is a possibility that one storage device among the plurality of storage devices may be intensively accessed by the plurality of client terminals. In this case, data traffic to/from the storage device per one client terminal is reduced by the requests of the plurality of client terminals.

In Japanese Patent Laid-Open No. 2003-345698, a data sharing system for realizing a high speed access to a disc device group on a network is described. In the data sharing system disclosed in Japanese Patent Laid-Open No. 2003-345698, a mechanism just relating to file sharing on a storage area network is cited.

In Japanese Patent Laid-Open No. 2003-330622, an access management server for allocating a storage space and for easily setting an access authority for the storage space is described. The access management server described in Japanese Patent Laid-Open No. 2003-330622 can define access rights to distributed storage devices.

In Japanese Patent Laid-Open No. 2004-030437, a data management apparatus capable of disclosing presence of a shared directory to clients sharing the shared directory, in a system constituting a file server by use of a Network Attached Storage (NAS) apparatus, is described. The configuration of the data management apparatus disclosed in Japanese Patent Laid-Open No 2004-030437 is NAS, and in this apparatus, access to a previously allocated storage device is restricted.

As described above, each of, the conventional systems does not describe the allocation of the file and the distribution of access requests from client terminals to storage devices.

### SUMMARY OF THE INVENTION

In view of the foregoing and other exemplary problems, drawbacks and disadvantages, it is an exemplary feature of the present invention to provide a computer system configuring a file system on a virtual storage device with a plurality of storage devices wherein the computer system prevents requests received from a plurality of client terminals from concentrating to a storage device.

Specifically, the present invention provides a computer system which is capable of distributing the requests transmitted from the plurality of client terminals to a plurality of respective storage devices.

An exemplary computer system having a storage area network according to the present invention includes a plurality of storage devices, a plurality of client terminals, and a file server allocating virtual storage spaces to the plurality of storage devices for configuring a virtual storage device, wherein the file server includes an information table defining correspondences between the virtual storage spaces and the client terminals, and processes a request received from the client terminal for accessing the virtual storage device based on the information table.

An exemplary virtual storage management apparatus according to the present invention includes a file system manager allocating virtual storage spaces to a plurality of storage devices for configuring a virtual storage device, and a server memory including an information table defining correspondences between the virtual storage space of the virtual storage device and client terminals, wherein the file system manager includes a file system controller processing a request, received from the client terminal for accessing the virtual storage device, based on the information table.

An exemplary method of managing a virtual storage device configured by a plurality of storage devices includes: allocating virtual storage spaces to a plurality of storage devices so as to configure a virtual storage device respectively, defining correspondences between the virtual storage spaces and client terminals so that each of the client terminals corresponds to different storage device, receiving a-request including an identifier of the client terminal from the client terminal, and when the request comprises a write request, determining virtual storage space to be used corresponding to the identifier included in the request based on the correspondences, and transmitting a first transfer request for transferring data to the virtual storage space determined to be used to the client terminal.

An exemplary signal-bearing medium tangibly embodying a program of machine-readable instructions executable by a digital processing apparatus to perform a method of configuring a virtual storage space on a storage area network includes establishing an information table to define correspondences between the client terminals and virtual storage spaces in the virtual storage space.

### BRIEF DESCRIPTION OF THE DRAWINGS

FIG. 1 is a block diagram showing a configuration of a exemplary computer system of the present invention;

FIG. 2 is a block diagram showing configurations of a file server and a client terminal;

FIG. 3 is an explanatory view for explaining a configuration of the virtual storage device;

FIG. 4 shows configuration information of a virtual storage stored in a server memory;

FIG. 5 shows an information table in the,configuration information of the virtual storage;

FIG. 6 shows a flowchart at the time the file server receives a file generation request;

FIG. 7 shows a flowchart at the time the file server receives an IO (WRITE) request, and

FIG. 8 is a block diagram showing a configuration of another exemplary computer system of the present invention.

### DETAILED DESCRIPTION OF THE EXEMPLARY EMBODIMENTS

A file system of the present invention will be described in detail below with reference to the accompanying drawings.

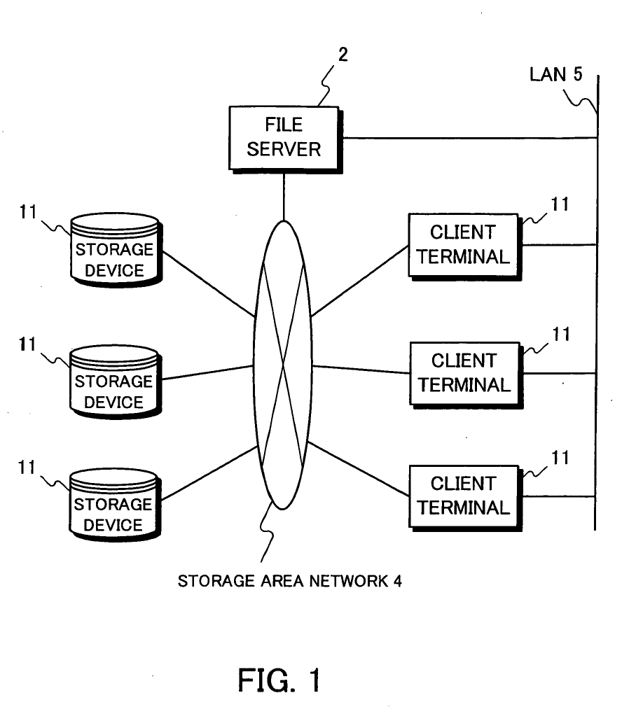

FIG. 1 is a block diagram showing a configuration of an exemplary computer system of the present invention. The computer system includes a file server 2, N storage devices, N client terminals, a storage area network (SAN) 4 and a local area network (LAN) 5. “N” is an integer not less than one. Assuming that “N” be 3, the N storage devices shall be storage devices 11, 12 and 13, and the N client terminals shall be client terminals 31, 32 and 33. Herein, for the sake of convenience, descriptions will be made on the premise that the storage devices and the client terminals -are in equal numbers. However, the numbers of them are not limited to be equal.

The storage devices 11, 12 and 13, the file server 2, and the client terminals 31, 32 and 33 are connected to a storage area network 4. The file server 2 and the client terminals 31, 32 and 33 are connected also to the LAN 5. The computer system configures a file system with a virtual storage device composed of the N storage devices.

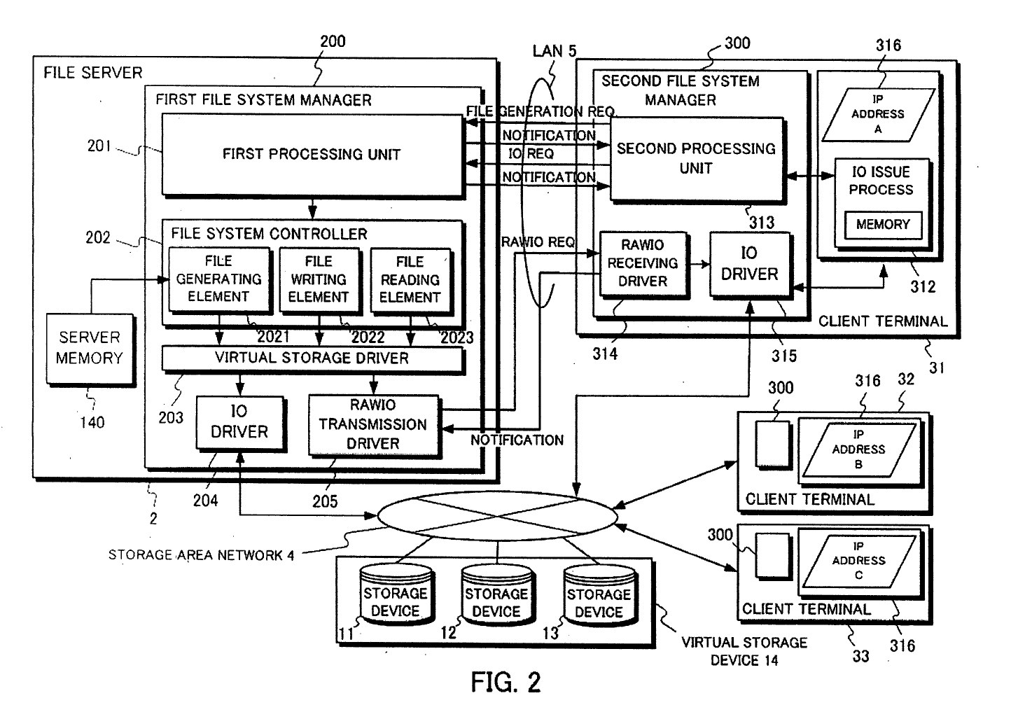

FIG. 2 is a block diagram showing configurations of the file server 2 and the client terminals 31-33.

The file server 2 as a virtual storage management apparatus includes a server memory 140 storing a computer program, and a first file system manager 200 for executing the computer program. The server memory 140 further stores configuration information 141 of a virtual storage device 14 to be described hereinafter. The first file system manager 200 includes a first processing unit 201, a file system controller 202, a virtual storage driver 203, an IO driver 204 and a RAWIO transmission driver 205. The file system controller 202 has a function to configure and manage the file system. The file system controller 202 includes a file generating element 2021, a file writing element 2022 and a file reading element 2023. The file generating element 2021, the file writing element 2022 and the file reading element 2023 refer to the configuration information of the configuration information 141 of the server memory 140.

The client terminal 31 includes a client memory 316 storing a computer program and a second file system manager 300 executing the computer program. The second file system manager 300 includes a second processing unit 313, a RAWIO receiving driver 314 and an IO driver 315. The client memory 316 further stores an IO issue process 312 for controlling the client terminal 31, and an IP address A. The IO issue process 312 includes data as occasion demands. The IP address A is an identifier for identifying the client terminal 31.

The client terminals 32 and 33 each include client memory 316 and second file system manager 300 respectively as in the case of the client terminal 31.

Note that the client memory 316 of the client terminal 32 stores an IP address B instead of the IP address A. The IP address B is an identifier for identifying the client terminal 32.

The client memory 316 of the client terminal 33 stores an IP address C instead of the IP address A. The IP address C is an identifier for identifying the client terminal 33.

The file server 2 allocates virtual storage spaces to the plurality of storage devices 11-13 for configuring a single virtual storage device 14.. The file system controller 202 of the file server controls the virtual storage driver 203 so that a single virtual storage device 14 is constituted. The virtual storage driver 203 allocates first, second and third virtual storage spaces of the virtual storage device 14 to the storage devices 11, 12 and 13, respectively, via the IO driver 204 and the SAN 4 by the control of the file system controller 202. In such manner, the file system controller 202 configures a file system on the virtual storage device 14.

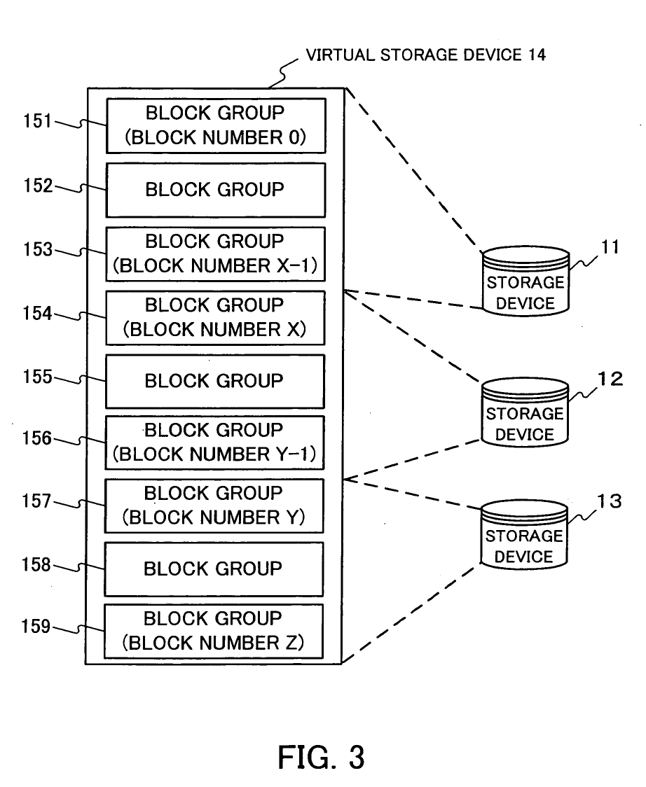

The generation of the file system will be described in more detail with reference to FIG. 3. The file system controller 202 is capable of configuring a single file system by constituting the virtual storage device 14 via the virtual storage driver 203, the IO driver 204 and the SAN 4. The file system controller 202 generates an aggregate of small file systems, which is called a “block group”, in one file system. In general, one block group is constituted of a superblock, a metadata management space and a data space. In the metadata management space, management data of an i node and free space are stored. The i node is a space for storing a pointer to a data space and file information. The file system controller 202 mounts (locally mounts) this file system, and sets the file system as a network file system (NFS) to be mountable from the client terminals 31, 32 and 33 via the NFS. Thus, when the file system controller 202 configures the file system on the virtual storage device 14, the file system controller 202 configures block groups 151, 152, 153, 154, 155, 156, 157, 158 and 159.

The first virtual storage space of the virtual storage device 14 is a space allocated to the block numbers 0 to X-1 among the block numbers 0 to Z. Herein, X and Z are integers, and satisfy an inequality X<Z. The first virtual storage space includes the block groups 151, 152 and 153.

The second virtual storage space of the virtual storage device 14 is a space allocated to the block numbers X to Y-1 among the block numbers 0 to Z. Herein, Y is an integer, and satisfies an inequality X<Y<Z. The second virtual storage space includes the block groups 154, 155 and 156.

The third virtual storage space of the virtual storage device 14 is a space allocated to the block,numbers Y to Z among the block numbers 0 to Z. The third virtual storage space includes the block groups 157, 158 and 159.

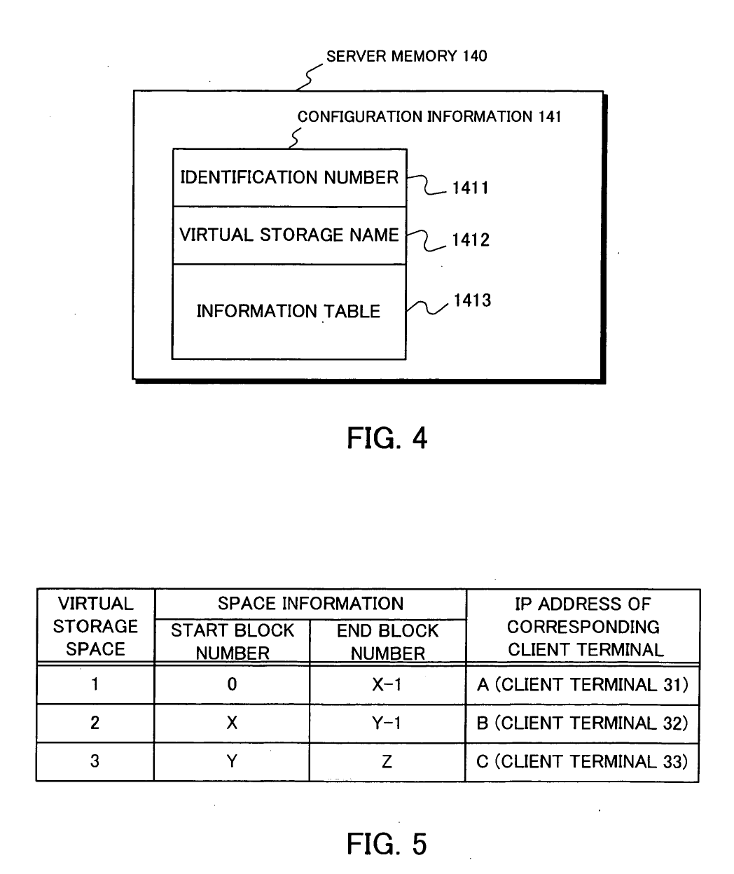

FIG. 4 shows the configuration information 141 of the virtual storage device 14 stored in the server memory 140 in this computer system. The configuration information 141 of the virtual storage device 14 includes an identification number 1411 which is an identifier for identifying the virtual storage device 14, a virtual storage name 1412 for representing a name of the virtual storage device 14, and an information table 1413.

FIG. 5 shows the information table 1413 which is a part of the configuration information 141 stored in the server memory 140. The information table 1413 stores includes space information representing an allocation of the virtual storage spaces 1-3 and an IP address of the client terminal corresponding to the virtual storage spaces 1-3. This data of the information table 1413 is variable-length data. The space information indicates a range of each virtual storage space allocated to the storage devices. The space information includes a start block number of the virtual storage space and an end block number of the virtual storage space.

The information table 1413 defines the correspondences between the virtual-storage space and the client terminals.

In this embodiment, the information table 1413 is generated so that the client terminals 31, 32 and 33 are allocated to the first, second and third virtual storage spaces, respectively. Namely, the information table 1413 preferably allocates each of the client terminals 31, 32 and 33 to different one of the storage devices 11, 12 and 13, respectively.

The file server 2 processes a request including a writing process from each client terminal for accessing the virtual storage device based on the information table 1413.

Referring to FIG. 5, descriptions of the foregoing allocations will be made. When, as the space information stored in the information table 1413, a start block takes a block number 0 and an end block takes a block number X-1, the IP address A which identifies the client terminal 31 is set to the client IP address.

When, as the space information stored in the information table 1413, the virtual storage start block takes a block number X and the virtual storage end block takes a block number Y-1, the IP address B is set to the client IP address.

When, as the space information stored in the information table 1413, the virtual storage start block takes a block number Y and the virtual storage end block takes a block number Z, the IP address C is set to the client IP address.

Next, descriptions for the file generating element 2021, the file writing element 2022 and the file reading element 2023 of the file system controller 202 will be made. For example, it is assumed that the IO issue process 312 of the client terminal 31 among the client terminals 31, 32 and 33 transmits an access request to the first file system manager 200 via the second processing unit 313 and the LAN 5. Herein, the access request includes an IP address of a source client terminal, that is, the IP address A. The first processing unit 201 of the file server 2 receives the access request from the client terminal 31.

The access request is any one of a file generation request and an IO request for a file. The IO request includes a WRITE instruction or a READ instruction.

When the access request is the file generation request, the first processing unit 201 calls up the file generating element 2021 of the file system controller 202. The file generating element 2021 refers to the information table 1413 in the configuration information 141 of the virtual storage device 14 in response to the file generation request. The file generating element 2021 checks whether the IP address coincident with the IP address A included in the file generation request exists in the information table 1413. As a result of the checks, the file generating element 2021 recognizes that the virtual storage space corresponding to the IP address A is the first virtual storage space.

Next, the file generating element 2021 checks the virtual storage space (the start block and the end block) corresponding to the IP address A in the information table 1413. The file generating element 2021 generates a file on the first virtual storage space between the block number 0 and the block number X-1 designated by the information table 1413 (file generation process). At this time, the file generating element 2021 determines any one of the block groups 151 to 153 of the first virtual storage space, and allocates an i node space and a file space to the determined block group (i node allocation process). The file generating element 2021 transmits a notification informing completion of the file generation in response to the access request (file generation request) to the second processing unit 313 of the client terminal 31 via the first processing unit 201 and the LAN 5.

As described above, the configuration information 141 is used when a file is generated on the file system constructed on the virtual storage device 14. If a system administrator has previously defined configuration information as a configuration file, the configuration information 141 is made to be referred to from the file generating element 2021 and the file writing element 2022.

When the access request is a WRITE request, the first processing unit 201 calls up the file writing element 2022 of the file system controller 202. The file writing element 2022 refers to the information table 1413 in the configuration information 141 in response to the WRITE request. Referring to the information table 1413, the file writing element 2022 checks whether the IP address coincident with the IP address A included in the WRITE request exists in the information table 1413. As a result of the checks, the file writing element 2022 recognizes that the virtual storage space corresponding to the IP address A is the first virtual storage space.

Next, the file writing element 2022 identifies the virtual storage space (the start block and the end block) corresponding to the IP address A in the information table 1413. The file writing element 2022 allocates, in response to the WRITE request, a space on the first virtual storage space, onto which the file is written (WRITE allocation process). At this time, the file writing element 2022 determines any one of the block groups 151 to 153 of the first virtual storage space, and allocates a space on the determined block group, to which the file is written. The file writing element 2022 transmits a raw (low level) IO request, which is a first transfer request, as a notification in response to the WRITE request, to the RAWIO receiving driver 314 of the client terminal 31 via the LAN 5. In this case, the low level IO corresponds to a SCSI write command, for example. Specifically, the raw IO request is a lower command than the IO request, and includes parameters of the storage device identifier for identifying the storage device 11, an operation. (WRITE), an offset value from the top of an access file, a block address, a block length and the like.

When the RAWIO receiving driver 314 of the client terminal 31 receives the raw IO request, the IO issue process 312 of the client terminal 31 accesses the storage device 11 via the SAN 4 in accordance with the parameters included in the raw IO request by using the IO driver 315. As a write operation, the IO issue process 312 of the client terminal 31 transfers data from the IO issue process 312 to the block address (storage device 11) determined to be used on the virtual storage device 14.

When the data transfer is completed, the RAWIO receiving driver 314 of the client terminal 31 transmits a raw IO completion notification to the RAWIO transmission driver 205 via the LAN 5. When the RAWIO transmission driver 205 receives the raw IO completion notification, the file writing element 2022 transmits an IO completion notification, as a notification in response to the raw IO completion notification, to the second processing unit 313 of the client terminal 31 via the first processing unit 201 and the LAN 5.

When the access request is a READ request, the first processing unit 201 calls up the file reading element 2023 of the file system controller 202. In response to the READ request, the file reading element 2023 locates a file which has been already allocated to the file system, and gets the file allocation on the located block group. As a notification in response to the READ request, the file reading element 2023 transmits a raw (low level) IO request, which is a second transfer request for reading out the file or data, to the RAWIO receiving driver 314 of the client terminal 31 via the LAN 5. In this case, the low level IO corresponds to a SCSI read command, for example, and is a lower command than the IO request as described in the descriptions for the foregoing WRITE request. The raw IO request includes parameters of the storage device identifier for identifying the storage device 11, an operation (READ), an offset value of an access file, a block address, a block length and the like.

When the RAWIO receiving driver 314 of the client terminal 31 receives the raw IO request, the IO issue process 312 of the client terminal 31 accesses the storage device via the SAN 4 by use of the IO driver 315, in accordance with the parameters included in the raw IO request. As a read operation, the IO issue process 312 of the client terminal 31 transfers data to the IO issue process 312 from the block address (located storage device) on the virtual storage device 14.

When the data transfer is completed, the RAWIO receiving driver 314 of the client terminal 31 transmits a raw IO completion notification to the RAWIO transmission driver 205 via the LAN 5. When the RAWIO transmission driver 205 receives the raw IO completion notification, the file reading element 2023 transmits an IO completion notification, as a notification in response to the raw IO completion notification, to the second processing unit 313 of the client terminal 31 via the first processing unit 201 and the LAN 5.

These operations are performed also for the client terminals 32 and 33 as in the case of the client terminal 31.

In this embodiment, the file server 2 preferentially allocates the storage devices 11, 12 and 13 to the client terminals 31, 32 and 33, respectively, by use of the information table 1413. Specifically, in the information table 1413, the space information which represents the first virtual storage space (block groups 151 to 153) being allocated to the storage device 11 and the IP address A of the client terminal 31 are stored while being allowed to correspond to each other. Further, the space information which represents the second virtual storage space (block groups 154 to 156) being allocated to the storage device 12 and the IP address B of the client terminal 32 are stored while being allowed to correspond to each other. Furthermore, the space information which represents the third virtual storage space (block groups 157 to 159) being allocated to the storage device 13 and the IP address C of the client terminal 33 are stored while being allowed to correspond to each other.

Therefore, in a case where the plurality of client terminals 31, 32 and 33 make access requests for accessing the virtual storage device 14, for example, a request for generating a file or an IO request, the accesses are not concentrated to one storage device among the plurality of storage devices 11, 12 and 13. Accordingly, the plurality of client terminals 31, 32 and 33 can make the access requests.

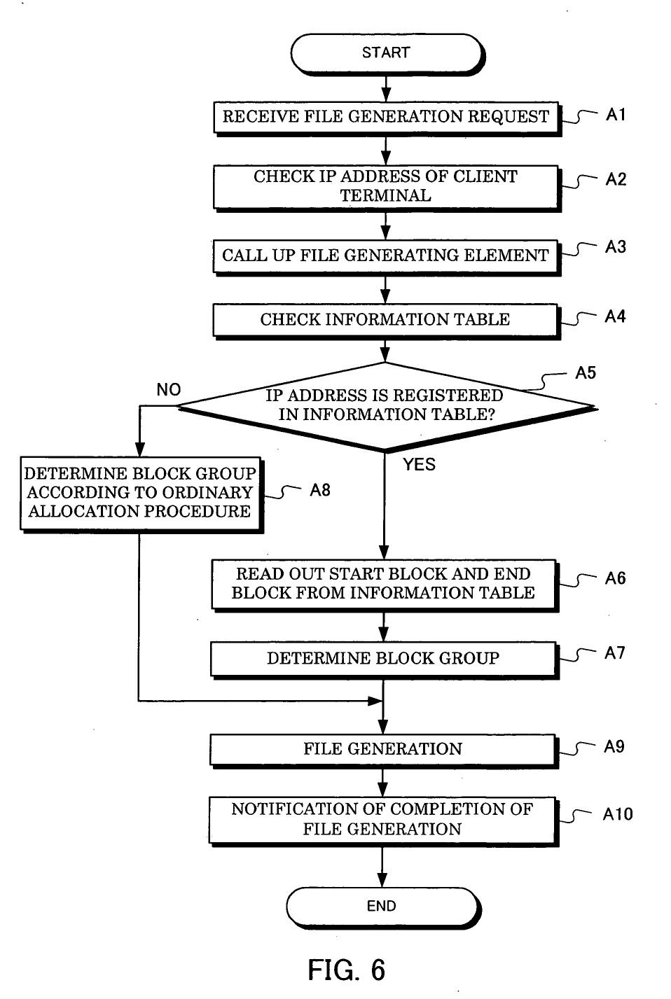

FIG. 6 shows a flowchart at the time the file server 2 receives the file generation request as an operation of the computer system of the present invention.

Assuming that the IO issue process 312 of the client terminal 31 issues a file generation request as an access request, and transmits it via the second processing unit 313 and the LAN 5.

First of all, the first processing unit 201 receives the file generation request (Step A1 of FIG. 6). The first processing unit 201 checks the IP address of the client terminal by referring to the IP address included in the file generation request (Step A2). Herein, the first processing unit 201 finds IP address A in the file generation request. Next, the first processing unit 201 calls up the file generating element 2021 in the file system controller 202 (Step A3). At this time, an argument includes the IP address A, which is the identifier of the client terminal.

The file generating element 2021 reads out the configuration information 141 from the server memory 140, and identifies a virtual storage space corresponding to the identifier included in the file generation request. Namely, the file generating element 2021 checks whether the IP address A included in the file generation request is registered in the information table 1413 in the configuration information 141 (Step A4).

In a case where the IP address A included in the file generation request has been registered in the information table 1413 (YES in Step A5), the file generating element 2021 reads out the start block number (block number 0) and the end block number (block number X-1) corresponding to the IP address A from the configuration information 141 of the virtual storage device 14 (Step A6). Subsequently, in the virtual storage device 14, the file generating element 2021 locates the block groups 151 to 153, which are within a range from the read-out start block (block number 0)to the read-out end block (block number X-1), in accordance with the file generation request. The file generating element 2021 determines the virtual storage space to be used. Specifically, the file generating element 2021 determines a block group, which is suitable for generating the file, among the block groups 151 to 153 (Step A7).

In a case where the IP address A included in the file generation request is not registered in the information table 1413 (NO in Step A5), the file generating element 2021 determines a block group according to an ordinary allocation procedure (Step A8). The “ordinary allocation procedure” means that the same processing as a conventional case in which a correspondence between the client terminal and the storage device is not defined is executed. Specifically, an allocation is not limited for the request. When the number of client terminals which are not registered in the information table 1413 increases, a probability that access requests are issued to the same storage device becomes higher. Therefore, it is desirable that the client terminal is registered in the information table.

Next, the file generating element 2021 performs the foregoing file generation process (Step A9). This file generation process includes the foregoing i node allocation process. Thereafter, the file generating element 2021 transmits a notification of completion of file generation to the second processing unit 313 of the client terminal 31 via the first processing unit 201 and the LAN 5 (Step A10).

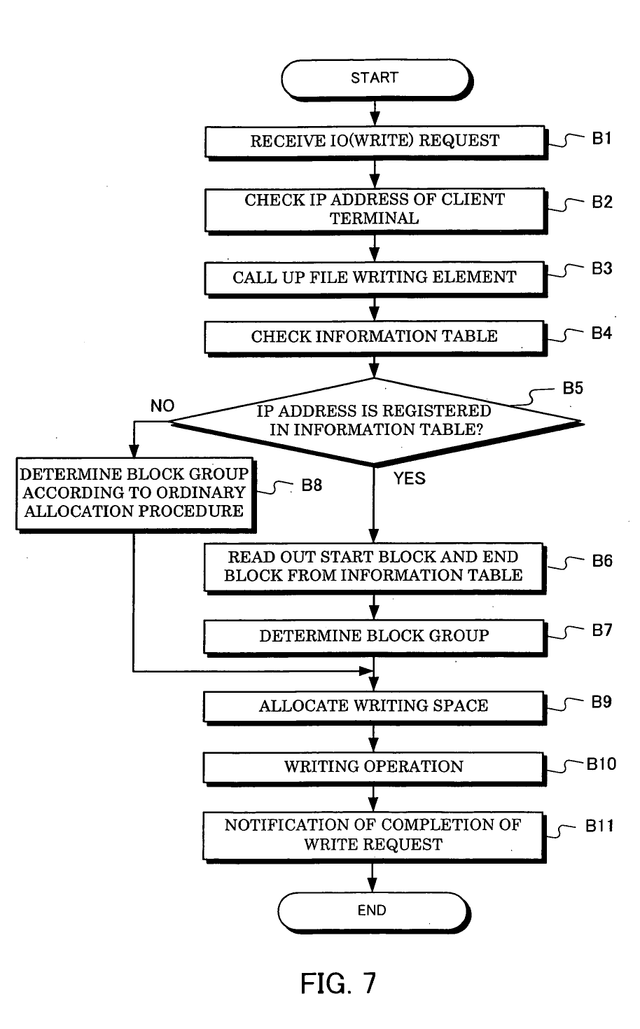

FIG. 7 shows a flowchart at the time the file server 2 receives the WRITE request as an operation of the file system of the present invention.

Assuming that the IO issue process 312 transmits a WRITE request as an access request via the second processing unit 313 and the LAN 5.

First of all, the first processing unit 201 receives the WRITE, request (Step B1 of FIG. 7). At this time, the first processing unit 201 checks the IP address of the client terminal by referring to the IP address included in the WRITE request (Step B2). Herein, the first processing unit 201 finds IP address A in the WRITE request. Next, the first processing unit 201 calls up the file writing element 2022 in the file system controller 202 (Step B3). At this time, an argument includes the IP address A.

The file writing element 2022 reads out the configuration information 141 from the server memory 140. The file writing element 2022 checks whether the IP address A included in the WRITE request is registered in the information table 1413 in the configuration information 141 (Step B4).

In a case where the IP address A included in the WRITE request has been registered in the information table 1413 (YES in Step B5), the file writing element 2022 reads out the start block number (block number 0) and the end block number (block number X-1) corresponding to the IP address A from the configuration information 141 of the virtual storage device 14 (Step B6). Subsequently, in the virtual storage device 14, the file writing element 2022 locates the block groups 151 to 153, which are within a range from the read-out start block (block number X) to the read-out end block (block number Y-1) The file writing element 2022 determines a block group, which is suitable for writing the file, among the block groups 151 to 153 (Step B7).

In a case where the IP address A included in the WRITE request is not registered in the information table 1413 (NO in Step B5), the file writing element 2022 determines a block group according to an ordinary allocation procedure (Step B8). The “ordinary allocation procedure” is the same as that described above.

Next, the file writing element 2022 allocates a space to which the file is written (Step B9). The file writing element 2022 transmits the raw IO request to the RAWIO receiving driver 314 of the client terminal 31 via RAWIO transmission driver 205 and the LAN 5. The file writing element 2022 makes the client terminal 31 execute an actual data writing (Step B10). At this time, the raw IO request includes parameters of the storage device identifier for identifying the storage device 11, an operation (WRITE), an offset value, a block address, a block length and the like. The RAWIO receiving driver 314 of the client terminal 31 receives the raw IO request. The IO issue process 312 of the client terminal 31 accesses the storage device 11 via the IO driver 315 and the SAN 4 in accordance with the parameters included in the raw IO request. The IO issue process 312 transfers data retained by the IO issue process 312 to the block address in the storage device 11, as a write operation.

Next, when the data transfer is completed, the RAWIO receiving driver 314 of the client terminal 31 transmits a raw IO completion notification to the RAWIO transmission driver 205 via the LAN 5. When the RAWIO transmission driver 205 receives the raw IO completion notification, the file writing element 2022 transmits a notification of IO completion (WRITE request completion notification) to the second processing unit 313 of the client terminal 31 via the first processing unit 201 and the LAN 5.

These operations are performed also for the client terminals 32 and 33 as in the case of the client terminal 31.

As described above, in the computer system of the present invention, a file server 2 allocates the storage devices 11, 12 and 13 (block groups 151 to 153, 154 to 156, and 157 to 159) to the client terminals 31, 32 and 33, respectively, by use of the information table 1413. For this reason, the file server 2 can distribute the access requests, which are transmitted from the plurality of client terminals 31, 32 and,33, to the plurality of storage devices 11, 12 and 13, respectively. The access requests are requests accompanied by a write operation to the storage device such as the file generation request and the WRITE request. Therefore, the processing can be quickly executed without concentration of the accesses to one storage device even when the plurality of client terminals 31, 32 and 33 simultaneously make the access requests.

In the computer system of the present invention, the storage area network 4 and the LAN 5 can be constituted of a single network by technologies such as iSCSI.

Furthermore, though the number of client terminals and the number of storage devices are 3 (N=3) above, the benefit of the invention would be provided even if N=2. Thus, the number thereof may be 2 or more with the benefit of the invention increasing as N increases. Still furthermore, though the IP address is exemplified as the identifier of the client, an identifier other than the IP address will do as long as it is a specific identifier for uniquely identifying the client.

Moreover, the virtual storage device 14 can be constituted by configuring a plurality of storage devices for striping, and a plurality thereof can also be integrated.

Furthermore, a plurality of client IP addresses can be defined for the same space in the information table 1413.

When there is not enough free capacity in the block groups within a range from the storage start block to the storage end block, which are defined by the information table 1413, a configuration in which the i node and the file space are allocated according to an ordinary allocation procedure may be adopted. In this case, it is possible to maintain an interface of the conventional file system which can effectively utilize a file space and in which a client can utilize, up to the total capacity of the storage.

Furthermore, the computer system can be applied also to a server of a network file system of a direct attached storage (DAS) In this case, in the server side, a plurality of IO controllers are provided, and the IO controllers and storage devices are connected one-to-one, whereby the IO controllers and the storage devices can be operated effectively.

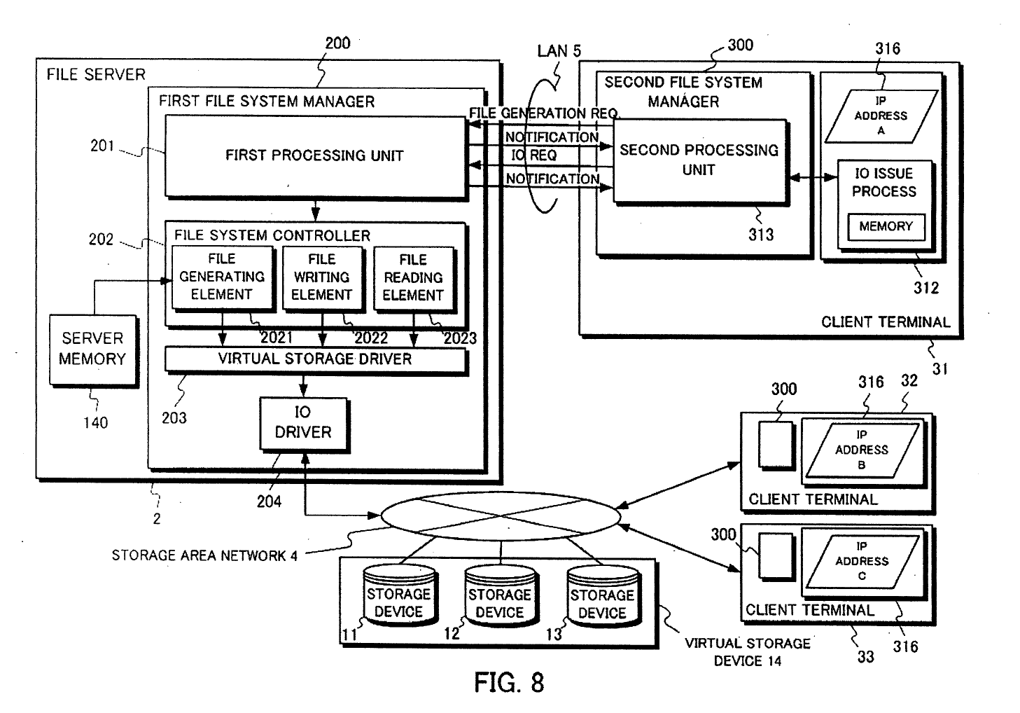

Referring to FIG. 8 to describe another embodiment, as an operation corresponding to the IO request from the client terminal, the file server 2 does not issue a raw IO request to the client terminals 31, 32 and 33. The IO driver 204 of the file server 2 performs input/output to/from the virtual storage device 14 with a determination of the virtual storage space to be used. Specifically, the same operation is performed for the virtual storage device 14 by the file server 2 as in the case of the file generation request. In this case, the RAWIO transmission driver 205 and the RAWIO receiving driver 314 are unnecessary.

When the client terminals 31, 32 and 33 make the WRITE request, the second processing unit 313 transmits write data to the first processing unit 201 together with the IO request. Processes after the transmission of the write data by the second processing unit 313 are the same as the Steps B2 to B9 of FIG. 7. After execution of Step B9, the file writing element 2022 issues a raw IO request to the virtual storage device 14 via the IO driver 204 to execute the IO processing. When the IO processing is completed, the file writing element 2022 transmits an IO completion notification (WRITE request completion notification) to the second processing unit 313 of the client terminal 31 via the first processing unit 201 and the LAN 5. In addition, the same processes are performed for the READ request.

A file server 2 allocates a plurality of storage devices 11, 12 and 13 (151 to 153, 154 to 156, and 157 to 159), to a plurality of client terminals 31, 32 and 33, respectively, by the information table 1413. For this reason, the file server 2 can distribute access requests, file generation requests, IO (WRITE) requests and the like, which are transmitted from the plurality of client terminals 31, 32 and 33, to the plurality of storage devices 11, 12 and 13, respectively. Therefore, the plurality of client terminals 31, 32 and 33 can make their access requests simultaneously without concentrating accesses to a storage device.

In the exemplary computer system of the present invention, the files used by the plurality of client terminals 31, 32 and 33 are allocated on the storage area network 4. The access requests transmitted from the plurality of client terminals 31, 32 and 33 can be distributed to the plurality of storage devices 11, 12 and 13, respectively.

The present invention has been described in detail. However, it should be appreciated that various changes may be made to the present invention without departing from its spirits and be covered by the claims.

Furthermore, it is the inventor's intent to retain all equivalents of the claimed invention even if the claims are amended during prosecution.

1. A computer system, comprising:
a plurality of storage devices;
a plurality of client terminals, and
a file server allocating virtual storage spaces to said plurality of storage devices for configuring a virtual storage device, wherein
said file server includes an information table defining correspondences between said virtual storage spaces and said client terminals, and processes a request received from said client terminal for accessing said virtual storage device based on said information table.

2. The computer system according to claim 1, wherein said client terminals, said file server and said storage devices are connected to said storage area network, and said client terminals and said file server are connected by a local area network.

3. The computer system according to claim 1, wherein
said request includes an identifier for identifying the client terminal sending said request, and
said information table includes space information indicating a range of said virtual storage space and said identifier of said client terminal corresponding to said range of virtual storage space.

4. The computer system according to claim 3, wherein said file server allocates virtual storage spaces to said storage devices respectively, and defines correspondences between said virtual storage spaces and said client terminals so that each of said client terminals corresponds to a different storage device.

5. The computer system according to claim 4, wherein said space information includes a start block number and an end block number of each virtual storage space.

6. The computer system according to claim 4, wherein said file server refers to said information table in response to said request from said client terminal, identifies virtual storage space corresponding to an identifier included in said request, and determines virtual storage space to be used.

7. The computer system according to claim 6, wherein said file server transmits a transfer request to said client terminal identified by said identifier to access said virtual storage space determined to be used.

8. The computer system according to claim 7, wherein said request is accompanied by a write operation to said virtual storage device and said transfer request comprises a low level IO request.

9. The computer system according to claim 6, wherein said file server executes said request in accordance with said determination of said virtual storage space to be used.

10. The computer system according to claim 7, wherein, when said identifier included in said request is not registered in said information table, said file server determines the virtual storage space to be used without said information table.

11. The computer system according to claim 6, wherein, when said virtual storage space determined to be used has not enough free capacity, said file server determines the virtual storage space to be used without said information table.

12. The apparatus according to claim 4, wherein:
when said request comprises a write request, said file server determines virtual storage space to be used corresponding to an identifier included in said request by referring to said information table, and transmits a first transfer request for transferring data to said virtual storage space determined to be used to said client terminal, and
when said request comprises a read request, said file server locates data to be read which has been allocated to said virtual storage device, and transmits a second transfer request for reading out said data from said virtual storage device to said client terminal.

13. A virtual storage management apparatus, comprising:
a file system manager allocating virtual storage spaces to a plurality of storage devices for configuring a virtual storage device, and
a server memory including an information table defining correspondences between said virtual storage space of said virtual storage device and client terminals, wherein said file system manager includes a file system controller processing a request, received from said client terminal for accessing said virtual storage device, based on said information table.

14. The apparatus according to claim 13, wherein
said request includes an identifier for identifying the client terminal sending said request, and
said information table includes space information indicating a range of said virtual storage space and said identifier of said client terminal corresponding to said range of virtual storage space.

15. The apparatus according to claim 14, wherein said file system manager further includes a virtual storage driver allocating said virtual storage spaces to said storage devices respectively, and said file system manager defines correspondences between said virtual storage spaces and said client terminals so that each of said client terminals corresponds to a different storage device.

16. The apparatus according to claim 15, wherein said file system controller refers to said information table in response to said request from said client terminal, identifies virtual storage space corresponding to an identifier included in said request, and determines virtual storage space to be used.

17. The apparatus according to claim 16, wherein said file system controller transmits a transfer request to said client terminal identified by said identifier to access said virtual storage space determined to be used.

18. The apparatus according to claim 17, wherein said request is accompanied by a write operation to said virtual storage device and said transfer request comprises a low level IO request.

19. The apparatus according to claim 16, wherein said file system controller executes said request in accordance with a determination of said virtual storage space to be used.

20. The apparatus according to claim 17, wherein in a case where said identifier included in said request is not registered in said information table, said file system controller determines the virtual storage space to be used without said information table.

21. The apparatus according to claim 17, wherein in a case where said virtual storage space determined to be used has not enough free capacity, said file system controller determines the virtual storage space to be used without said information table.

22. The apparatus according to claim 15, wherein
when said request comprises a write request, said file system controller determines virtual storage space to be used corresponding to an identifier included in said request by referring to said information table, and transmits a first transfer request for transferring data to said virtual storage space determined to be used to said client terminal, and
when said request comprises a read request, said file system controller locates data to be read which has been allocated to said virtual storage device, and transmits a second transfer request for reading out said data from said virtual storage device to said client terminal.

23. A method of managing a virtual storage device configured by a plurality of storage devices, said method comprising:
allocating virtual storage spaces to a plurality of storage devices so as to configure a virtual storage device respectively;
defining correspondences between said virtual storage spaces and client terminals so that each of said client terminals corresponds to different storage device;
receiving a request including an identifier of said client terminal from said client terminal, and
when said request comprises a write request, determining virtual storage space to be used corresponding to said identifier included in said request based on said correspondences, and transmitting a first transfer request for transferring data to said virtual storage space determined to be used to said client terminal.

24. The method according to claim 23,wherein:
when said request comprises a read request, locating data to be read which has been allocated to said virtual storage device, and transmitting a second transfer request for reading out said data from said virtual storage device to said client terminal.

25. A method of managing a virtual storage device configured by a plurality of storage devices, said method comprising:
allocating virtual storage spaces to a plurality of storage devices so as to configure a virtual storage device respectively;
defining correspondences between said virtual storage spaces and client terminals so that each of said client terminals corresponds to different storage device;
receiving an request including an identifier of said client terminal from said client terminal, and
when said request comprises a write request, determining virtual storage space to be used corresponding to said identifier included in said request based on said correspondences.

26. The method according to claim 25, wherein:
when said request comprises a read request, locating data to be read which has been allocated to said virtual storage device, and
executing said request in accordance with said determination or said location.

27. A signal-bearing medium tangibly embodying a program of machine-readable instructions executable by a digital processing apparatus to perform a method of configuring a virtual storage space on a storage area network, said method comprising:
establishing an information table to define correspondences between client terminals and virtual storage spaces in said virtual storage space.

28. The signal-bearing medium of claim 27, wherein said method further comprises:
receiving a request received from one of said client terminals for accessing said virtual storage space, and
processing said received request based on said information table.

29. A computer system having a storage area network, comprising:
a plurality of storage devices, and
a file server means for allocating virtual storage spaces to said plurality of storage devices for configuring a virtual storage device, wherein
said file server means includes an information table defining correspondences between said virtual storage spaces and client terminals, and processes a request received from said client terminal for accessing said virtual storage device based on said information table.

30. A virtual storage management apparatus, comprising:
a file system managing means for allocating virtual storage spaces to a plurality of storage devices for configuring a virtual storage device, and
a server memory means for including an information table defining correspondences between said virtual storage space of said virtual storage device and client terminals, wherein
said file system managing means includes a file system controlling means for processing a request, received from said client terminal for accessing said virtual storage device, based on said information table.
